(19) United States
(12) Patent Application Publication
(10) Pub. No.: US 2020/0182068 A1
(43) Pub. Date: Jun. 11, 2020

(54) AXIAL FLOW COOLING SCHEME WITH STRUCTURAL RIB FOR A GAS TURBINE ENGINE

(71) Applicant: United Technologies Corporation, Farmington, CT (US)

(72) Inventors: Brandon W. Spangler, Vernon, CT (US); Adam P. Generale, Dobbs Ferry, NY (US)

(73) Assignee: United Technologies Corporation, Farmington, CT (US)

(21) Appl. No.: 16/210,606

(22) Filed: Dec. 5, 2018

(51) Int. Cl. F01D 5/18; F01D 9/04

(52) U.S. Cl. CPC F01D 5/187; F05D 2260/22141; F05D 2240/126; F01D 9/041

(57) ABSTRACT

A component for a gas turbine engine. The component includes a first multiple of axial standoff ribs that extend from the first sidewall and a second multiple of axial standoff ribs that extend from the second sidewall. The structural rib that extends between the first multiple of axial standoff ribs and the second multiple of axial standoff ribs.

### BACKGROUND

The present disclosure relates to a gas turbine engine and, more particularly, to a cooling scheme for an airfoil.

Gas turbine engines typically include a compressor section to pressurize flow, a combustor section to burn a hydrocarbon fuel in the presence of the pressurized air, and a turbine section to extract energy from the resultant combustion gases. The combustion gases commonly exceed 2000 degrees F. (1093 degrees C.).

Cooling of engine components is performed via communication of cooling flow through airfoil cooling circuits. Due to casting size limitations of trailing edge slots from the airfoil cooling circuit, trailing edge flow provides a significant portion of the cooling flow in a component. Axial flow baffle designs can utilize this trailing edge flow efficiently to cool the balance of the component, eliminating the complexity of dedicated cooling flow in other regions of the component. However, in order to prevent the pressure and suction side walls from bulging with minimal weight impact, stiffening features are utilized to tie the pressure and suction side walls together which may further interfere with the flow.

### SUMMARY

A component for a gas turbine engine according to one disclosed non-limiting embodiment of the present disclosure includes a first multiple of axial standoff ribs that extend from the first sidewall, a second multiple of axial standoff ribs that extend from the second sidewall; and a structural rib that extends between the first multiple of axial standoff ribs and the second multiple of axial standoff ribs.

In the alternative or additionally thereto, the foregoing embodiment includes that the first sidewall is a pressure side and the second sidewall is a suction side of an airfoil.

In the alternative or additionally thereto, the foregoing embodiment includes that the first sidewall and the second sidewall extend between an outer vane platform and an inner vane platform.

In the alternative or additionally thereto, the foregoing embodiment includes that the structural rib extends between an outer vane platform and an inner vane platform.

In the alternative or additionally thereto, the foregoing embodiment includes at least one baffle adjacent to the structural rib.

In the alternative or additionally thereto, the foregoing embodiment includes a forward baffle section adjacent to the structural rib and an aft baffle section adjacent to the structural rib.

In the alternative or additionally thereto, the foregoing embodiment includes that each of the first multiple of axial standoff ribs meet with one of the second multiple of axial standoff ribs at a leading edge.

In the alternative or additionally thereto, the foregoing embodiment includes that each of the first multiple of axial standoff ribs and each of the second multiple of axial standoff ribs extends forward of a multiple of trailing edge apertures.

In the alternative or additionally thereto, the foregoing embodiment includes that the component is a turbine vane.

In the alternative or additionally thereto, the foregoing embodiment includes that the structural rib is connected to the first and second multiple of axial standoff ribs but not the first sidewall and the second sidewall.

In the alternative or additionally thereto, the foregoing embodiment includes that the structural rib and the first and second multiple of axial standoff ribs form a multiple of axial passages.

In the alternative or additionally thereto, the foregoing embodiment includes that the multiple of axial passages extend between each of the multiple of axial standoff ribs.

In the alternative or additionally thereto, the foregoing embodiment includes that each of the multiple of axial passages are defined between a baffle, the structural rib, the multiple of axial standoff ribs, and the respective first and second sidewalls.

A vane for a gas turbine engine according to one disclosed non-limiting embodiment of the present disclosure includes a first multiple of axial standoff ribs that extend from the pressure sidewall; a second multiple of axial standoff ribs that extend from the suction sidewall; a structural rib that extends between the first multiple of axial standoff ribs and the second multiple of axial standoff ribs; and at least one baffle adjacent to the structural rib.

In the alternative or additionally thereto, the foregoing embodiment includes a forward baffle section adjacent to the structural rib and an aft baffle section adjacent to the structural rib.

In the alternative or additionally thereto, the foregoing embodiment includes that the structural rib is connected to the first and second multiple of axial standoff ribs but not the suction sidewall and the pressure sidewall. In the alternative or additionally thereto, the foregoing embodiment includes that the structural rib, the first multiple of axial standoff ribs, the second multiple of axial ribs, the suction sidewall, and the pressure sidewall form a multiple of axial passages.

In the alternative or additionally thereto, the foregoing embodiment includes that each one of the multiple of axial passages extend between each of the multiple of axial standoff ribs.

A method of communicating flow within a vane of a gas turbine engine component, the method according to one disclosed non-limiting embodiment of the present disclosure includes flowing a cooling flow around a baffle and through a multiple of axial passages between a structural rib and a sidewall.

In the alternative or additionally thereto, the foregoing embodiment includes that the cooling flow exits a leading edge of the baffle.

The foregoing features and elements may be combined in various combinations without exclusivity, unless expressly indicated otherwise. These features and elements as well as the operation thereof will become more apparent in light of the following description and the accompanying drawings. It should be appreciated; however, the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiments. The drawings that accompany the detailed description can be briefly described as follows:

FIG. 1 is a schematic cross-section of an example gas turbine engine architecture.

FIG. 2 is a schematic cross-section of an engine turbine section including a vane ring.

FIG. 3 is a front view of the vane ring.

FIG. 4 is a perspective view of one example vane doublet used in the vane ring that includes two airfoils.

FIG. 5 is a partial phantom perspective view of a single airfoil within the vane doublet.

FIG. 6 is a sectional view taken along line 6-6 in FIG. 5.

FIG. 7 is a sectional view taken along line 7-7 in FIG. 5.

FIG. 8 is a sectional view taken along line 8-8 in FIG. 5.

FIG. 9 is a block diagram of a method for the airfoil within the vane doublet.

FIG. 10 is an exploded view of the airfoil within the vane doublet.

### DETAILED DESCRIPTION

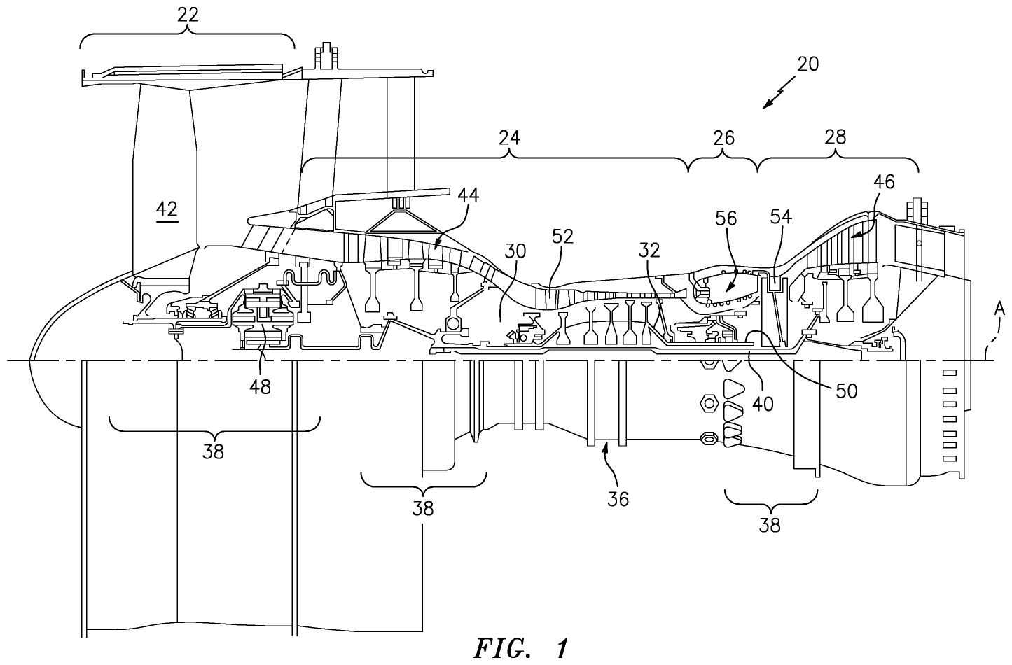

FIG. 1 schematically illustrates a gas turbine engine 20. The gas turbine engine 20 is disclosed herein as a two-spool turbo fan that generally incorporates a fan section 22, a compressor section 24, a combustor section 26 and a turbine section 28. The fan section 22 drives air along a bypass flowpath while the compressor section 24 drives air along a core flowpath for compression and communication into the combustor section 26 then expansion through the turbine section 28. Although depicted as a turbofan in the disclosed non-limiting embodiment, the concepts described herein may be applied to other turbine engine architectures such as turbojets, turboshafts, and three-spool (plus fan) turbofans.

The engine 20 generally includes a low spool 30 and a high spool 32 mounted for rotation about an engine central longitudinal axis A relative to an engine case structure 36 via several bearing structures 38. The low spool 30 generally includes an inner shaft 40 that interconnects a fan 42, a low pressure compressor (“LPC”) 44 and a low pressure turbine (“LPT”) 46. The inner shaft 40 drives the fan 42 directly or through a geared architecture 48 to drive the fan 42 at a lower speed than the low spool 30. An exemplary reduction transmission is an epicyclic transmission, namely a planetary or star gear system.

The high spool 32 includes an outer shaft 50 that interconnects a high pressure compressor (“HPC”) 52 and high pressure turbine (“HPT”) 54. A combustor 56 is arranged between the high pressure compressor 52 and the high pressure turbine 54. The inner shaft 40 and the outer shaft 50 are concentric and rotate about the engine central longitudinal axis A which is collinear with their longitudinal axes.

Core flow is compressed by the LPC 44 then the HPC 52, mixed with the fuel and burned in the combustor 56, then the combustion gasses are expanded over the HPT 54 and the LPT 46. The turbines 46, 54 rotationally drive the respective low spool 30 and high spool 32 in response to the expansion. The main engine shafts 40, 50 are supported at a plurality of points by bearing assemblies 38 within the engine case structure 36.

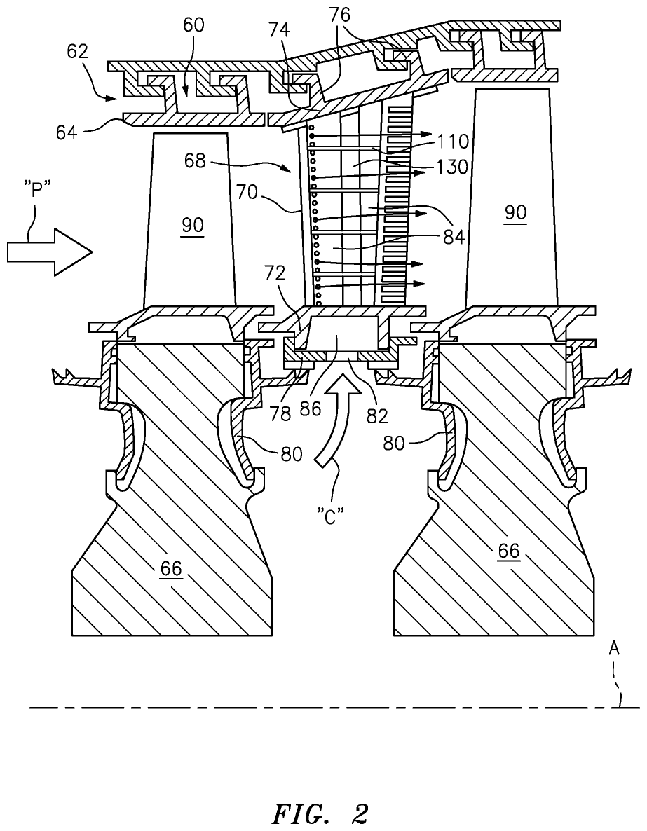

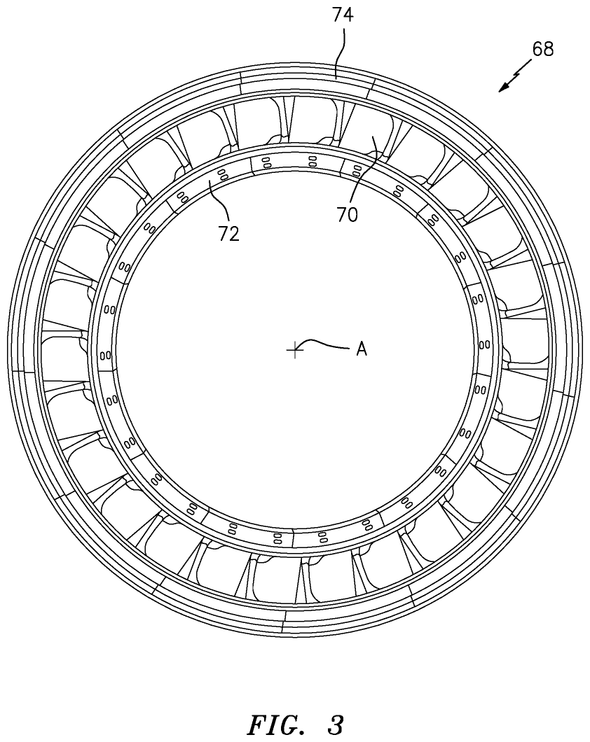

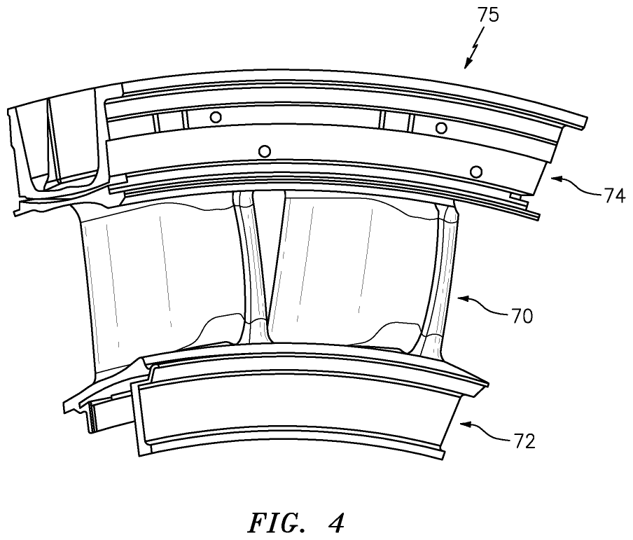

With reference to FIG. 2, an enlarged schematic view of a portion of the turbine section 28 is shown by way of example. A full ring shroud assembly 60 within the engine case structure 36 supports a blade outer air seal (BOAS) assembly 62. The blade outer air seal (BOAS) assembly 62 contains a multiple of circumferentially distributed BOAS 64 proximate to a rotor assembly 66. The full ring shroud assembly 60 and the blade outer air seal (BOAS) assembly 62 are axially disposed adjacent to a first stationary vane ring 68 (also shown in FIG. 3). The vane ring 68 includes an array of vanes 70 between a respective inner vane platform 72 and an outer vane platform 74. In this embodiment, the array of vanes 70 are formed as a multiple of vane doublets 75 (one shown in FIG. 4), however, other turbine component and vane arrangements will benefit herefrom. The outer vane platform 74 attach the vane ring 68 to the engine case structure 36.

The blade outer air seal (BOAS) assembly 62, the inner vane platform 72 and the outer vane platform 74 bounds the working medium combustion gas flow in a primary flow path P. The vane rings 68 align the flow while the rotor blades 90 collect the energy of the working medium combustion gas flow to drive the turbine section 28 which in turn drives the compressor section 24. The single rotor assembly 66 and the single stationary vane ring 68 are described in detail as representative of any number of multiple engine stages.

The first stationary vane ring 68 may be mounted to the engine case structure 36 by a multiple of segmented hooked rails 76 that extend from the outer vane platform 74. A full hoop inner air seal 78 that attaches to the inner vane platform 72 provides a seal surface for a full hoop cover plate 80 mounted to each rotor assembly 66. The full hoop inner air seal 78 includes a multiple of feed passages 82 that supply cooling air “C” to an airfoil cooling circuit 84 distributed within each respective vane 70. Each vane 70 receives the cooling air “C” from multiple of feed passages 82 that feeds a plenum 86 thence into each airfoil cooling circuit 84.

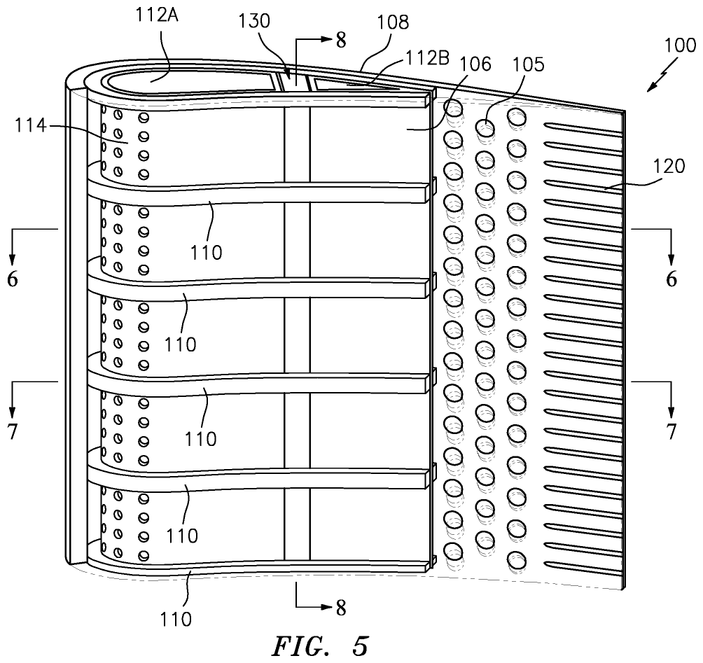

With reference to FIG. 5, one disclosed embodiment of the vane 70 includes an airfoil 100 that defines a blade chord between a leading edge 102, which may include various forward and/or aft sweep configurations, and a trailing edge 104. A first sidewall 106 that may be concave to define a pressure side, and a second sidewall 108 that may be convex to define a suction side are joined at the leading edge 102 and at the axially spaced trailing edge 104. A multiple of pedestals 105 may be located toward the trailing edge 104 to provide support therefor.

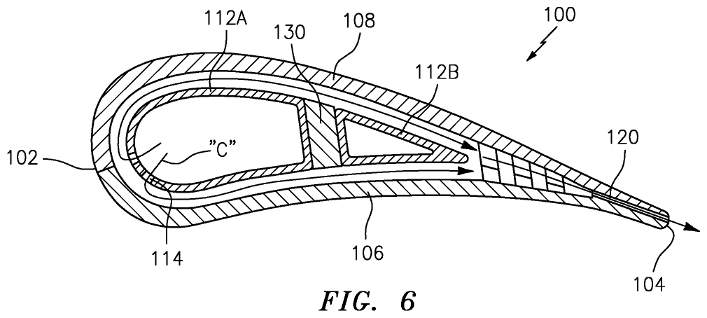

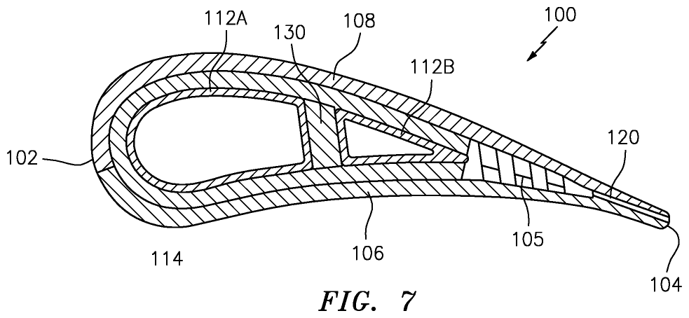

The first sidewall 106 and the second sidewall 108 includes a multiple of axial standoff ribs 110 that support a baffle 112 therein (FIGS. 6 and 7). The baffle 112 provides a conduit through which flow, electrical wires, or other may be directed span wise through the airfoil 100. Cooling air “C” from the baffle 112 is ejected through apertures 114 in a leading edge 102 of the baffle 112 which then flows around the leading edge 102 and along the sidewalls 106, 108 generally parallel to the multiple of axial standoff ribs 110 until ejected through the trailing edge apertures 120 (FIG. 7). Other apertures may alternatively or additionally be provided to feed the cooling air into the space between the baffle 112 and the sidewalls 106, 108.

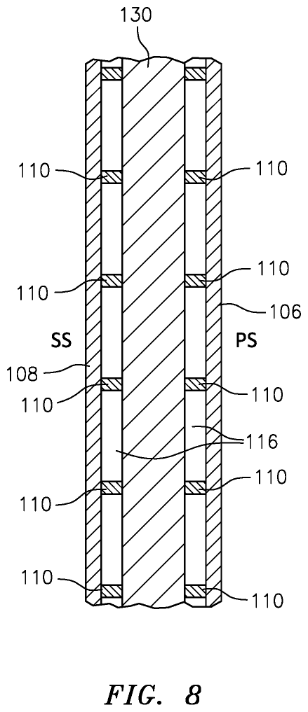

In this embodiment, the baffle 112 includes a forward section 112A and an aft section 112B adjacent to a structural rib 130 that extends between the multiple of axial standoff ribs 110. The structural rib 130 ties the first sidewall 106 to the second sidewall 108 at the multiple of axial standoff ribs 110 to prevent the pressure and suction sides from bulging due to a pressure differential across the wall, yet maintains thin sidewalls (FIG. 8). That is, the structural rib 130 is connected to the multiple of axial standoff ribs 110 (FIG. 7) but not the sidewall 106, 108 (FIG. 8).

The multiple of axial standoff ribs 110 provide axial passages 116 (FIG. 8) defined between the baffle 112, the structural rib 130, the multiple of axial standoff ribs 110, and the respective sidewalls 106, 108. Since the structural rib 130 extends span wise and the baffle 112 seats against the axial standoff ribs 110, the junction of the axial standoff ribs 110 and the structural rib 130 between the baffles 112A, 112B becomes a solid junction that extends fully between the sidewalls 106, 108, providing a stiff tie therebetween to prevent panel bulge. Moreover, since the structural rib 130 does not extend fully between the sidewalls 106, 108, the axial passages 116 allow cooling flow to travel axially from the leading edge 102 to the trailing edge 104. In other words, in the region of the structural rib 130 and the axial standoff ribs 110 (FIG. 8), the axial passages 116 are cutouts.

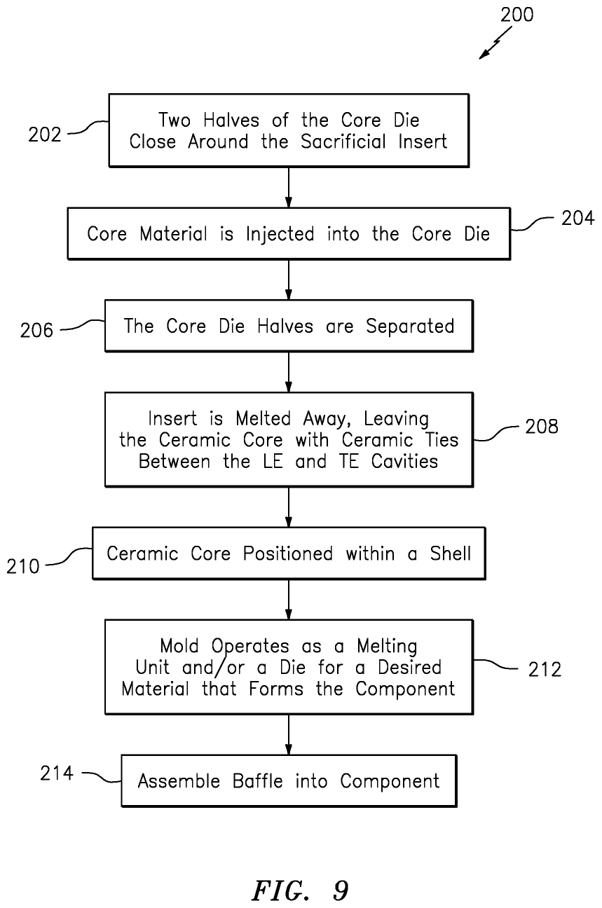

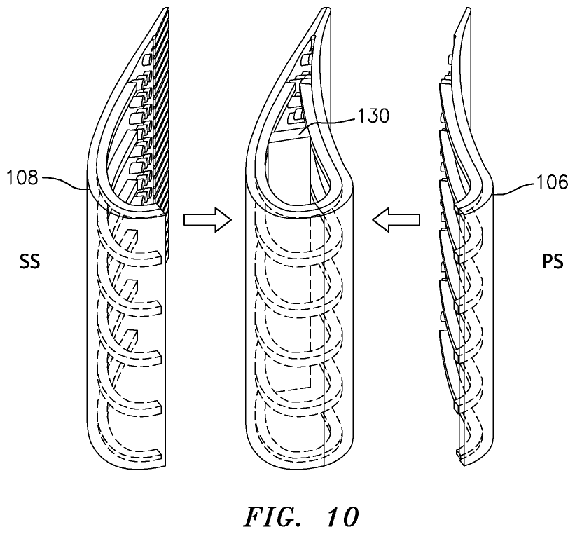

With reference to FIG. 9, while not to be limited to any single method, a method 200 for manufacturing the structural rib 130 may include utilization of a Refractory Metal Core (RMC) or other sacrificial insert. In one example, two halves of a core die are closed around the sacrificial insert (202; FIG. 10). One half of the core die includes the suction side wall complete with suction side half of trailing edge pedestals, heat transfer features, and axial standoff ribs. One half of the die includes the pressure side wall complete with pressure side half of trailing edge pedestals, heat transfer features, and axial standoff ribs.

Next, the core material is injected into the core die (204). Next, the core die halves are separated (206) and the sacrificial insert is melted away (208) which leaves a ceramic core with ceramic ties between the cavities that will form the structural rib 130.

The ceramic core is then positioned within a shell that defines the outer surface of the airfoil while the core forms the internal surfaces such as that which defines the multiple of axial standoff ribs 110 and the structural rib 130 (210). That is, during the casting process, the core fills a selected volume within the shell that, when removed from the finished casting, defines the array of internal passageways utilized for cooling flow. The shell and the core define a mold to cast complex exterior and interior geometries and may be formed of refractory metals, ceramic, or hybrids thereof. The mold thereby operates as a melting unit and/or a die for a desired material that forms the doublet (212). The desired material may include but not be limited to a superalloy or other material such as nickel based superalloy, cobalt based superalloy, iron based superalloy, and mixtures thereof. After casting and removal, the baffle 112 is inserted into the airfoil 100 (214). It should be appreciated that other steps may alternatively or additionally be provided.

Alternatively, or in addition, a single crystal starter seed or grain selector may be utilized to enable a single crystal to form when solidifying the component. The solidification may utilize a chill block in a directional solidification furnace. The directional solidification furnace has a hot zone that may be induction heated and a cold zone separated by an isolation valve. The chill block and may be elevated into the hot zone and filled with molten super alloy. Casting is typically performed under an inert atmosphere or vacuum to preserve the purity of the casting.

Alternatively, the vane and/or the baffle may be formed via an additive manufacturing process. The additive manufacturing process sequentially builds-up layers of materials that include but are not limited to, various titanium alloys including Ti 6-4, Inconel 625 Alloy, Inconel 718 Alloy, Haynes230 Alloy, stainless steel, tool steel, cobalt chrome, titanium, nickel, aluminum, ceramics, plastics and others in atomized powder material form. In other examples, the starting materials can be non-atomized powders, filled or unfilled resins in liquid, solid or semisolid forms, and wire-based approaches such as wire arc for metals and Fused Deposition Modeling (FDM) for polymers. Alloys such as Inconel 625, Inconel 718 and Haynes 230 may have specific benefit for high temperature environments, such as, for example, environments typically encountered by aerospace and gas turbine engine articles. Examples of the additive manufacturing processes include, but are not limited to, SFF processes, 3-D printing methods, Sanders Modelmaker, Selective Laser Sintering (SLS), 3D systems thermojet, ZCorp 3D printing Binder jetting, Extrude ProMetal 3D printing, stereolithography, Layered Object Manufacturing (LOM), Fused Deposition Modeling (FDDM), Electron Beam Sintering (EBS), Direct Metal Laser Sintering (DMLS), Electron Beam Melting (EBM), Electron Beam Powder Bed Fusion (EB-PBF), Electron Beam Powder Wire (EBW), Laser Engineered Net Shaping (LENS), Laser Net Shape Manufacturing (LNSM), Direct Metal Deposition (DMD), Laser Powder Bed Fusion (L-PBF), Digital Light Synthesis™ and Continuous Liquid Interface Production (CLIP™). Although particular additive manufacturing processes are recited, any rapid manufacturing method can alternatively or additionally be used. In addition while additive manufacturing is the envisioned approach for fabrication of vanes 70, alternate embodiments may utilize alternate manufacturing approaches including cast, brazed, welded or diffusion bonded structures.

The geometry provides the stiffness required to prevent airfoil panel bulge while allowing cooling flow to travel axially from the leading edge to trailing edge with minimal pressure loss. Moreover, although described with respect to vanes, the embodiments set forth in this application may be applied to other components of the engine, such as blades.

Although particular step sequences are shown, described, and claimed, it should be appreciated that steps may be performed in any order, separated or combined unless otherwise indicated and will still benefit from the present disclosure.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be appreciated that within the scope of the appended claims, the disclosure may be practiced other than as specifically described. For that reason, the appended claims should be studied to determine true scope and content.

What is claimed is:

1. A component for a gas turbine engine, comprising:
a first sidewall;
a first multiple of axial standoff ribs that extend from the first sidewall;
a second sidewall;
a second multiple of axial standoff ribs that extend from the second sidewall; and
a structural rib that extends between the first multiple of axial standoff ribs and the second multiple of axial standoff ribs.

2. The component as recited in claim 1, wherein the first sidewall is a pressure side and the second sidewall is a suction side of an airfoil.

3. The component as recited in claim 2, wherein the first sidewall and the second sidewall extend between an outer vane platform and an inner vane platform.

4. The component as recited in claim 3, wherein the structural rib extends between an outer vane platform and an inner vane platform.

5. The component as recited in claim 1, further comprising at least one baffle adjacent to the structural rib.

6. The component as recited in claim 1, further comprising a forward baffle section adjacent to the structural rib and an aft baffle section adjacent to the structural rib.

7. The component as recited in claim 1, wherein each of the first multiple of axial standoff ribs meet with one of the second multiple of axial standoff ribs at a leading edge.

8. The component as recited in claim 1, wherein each of the first multiple of axial standoff ribs and each of the second multiple of axial standoff ribs extends forward of a multiple of trailing edge apertures.

9. The component as recited in claim 1, wherein the component is a turbine vane.

10. The component as recited in claim 1, wherein the structural rib is connected to the first and second multiple of axial standoff ribs but not the first sidewall and the second sidewall.

11. The component as recited in claim 1, wherein the structural rib and the first and second multiple of axial standoff ribs form a multiple of axial passages.

12. The component as recited in claim 11, wherein the multiple of axial passages extend between each of the multiple of axial standoff ribs.

13. The component as recited in claim 11, wherein each of the multiple of axial passages are defined between a baffle, the structural rib, the multiple of axial standoff ribs, and the respective first and second sidewalls.

14. A vane for a gas turbine engine, comprising:
a pressure sidewall;
a first multiple of axial standoff ribs that extend from the pressure sidewall;
a suction sidewall;
a second multiple of axial standoff ribs that extend from the suction sidewall;
a structural rib that extends between the first multiple of axial standoff ribs and the second multiple of axial standoff ribs; and
at least one baffle adjacent to the structural rib.

15. The vane as recited in claim 14, further comprising a forward baffle section adjacent to the structural rib and an aft baffle section adjacent to the structural rib.

16. The vane as recited in claim 14, wherein the structural rib is connected to the first and second multiple of axial standoff ribs but not the suction sidewall and the pressure sidewall.

17. The vane as recited in claim 14, wherein the structural rib, the first multiple of axial standoff ribs, the second multiple of axial ribs, the suction sidewall, and the pressure sidewall form a multiple of axial passages.

18. The vane as recited in claim 17, wherein each one of the multiple of axial passages extend between each of the multiple of axial standoff ribs.

19. A method of communicating flow within a vane of a gas turbine engine component, the method comprising:
flowing a cooling flow around a baffle and through a multiple of axial passages between a structural rib and a sidewall.

20. The method as recited in claim 19, wherein the cooling flow exits a leading edge of the baffle.
